(19) United States
(12) Patent Application Publication
(10) Pub. No.: US 2026/0187629 A1
(43) Pub. Date: Jul. 2, 2026

(54) INITIATING BLOCKCHAIN MESSAGES BASED ON INTEGRATED USER INTERFACE BUTTON

(71) Applicant: Coinbase, Inc., Oakland, CA (US)

(72) Inventor: Alec Chen, New York City, NY (US)

(21) Appl. No.: 19/003,840

(22) Filed: Dec. 27, 2024

(51) Int. Cl. G06Q 20/38; G06F 3/0481; G06F 3/0484; G06Q 20/06; G06Q 20/36

(52) U.S. Cl. CPC G06Q 20/389; G06F 3/0481; G06F 3/0484; G06Q 20/0658; G06Q 20/36; G06Q 2220/10

(57) ABSTRACT

Methods, systems, and devices for data management are described. The described techniques may enable a user of a custodial token platform to select a button on a user interface of a client application to initiate a blockchain transaction to transfer an amount of crypto token to a destination address associated with a merchant of the client application. For example, in response to selection of the button, the client application may request one or more services to generate one or more calls that may cause the transfer of the crypto token. The client application may provide one or more calls to a blockchain address application. The custodial token platform may output the one or more calls to cause transfer of the crypto tokens.

### FIELD OF TECHNOLOGY

The present disclosure relates generally to data management, including techniques for initiating blockchain messages based on an integrated user interface button.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports initiating blockchain messages based on an integrated user interface button in accordance with aspects of the present disclosure.

FIG. 2 shows an example of a computing environment that supports initiating blockchain messages based on an integrated user interface button in accordance with aspects of the present disclosure.

FIG. 3 shows an example of a computing environment that supports initiating blockchain messages based on an integrated user interface button in accordance with aspects of the present disclosure.

FIG. 4 shows an example of a process flow that supports initiating blockchain messages based on an integrated user interface button in accordance with aspects of the present disclosure.

FIG. 5 shows a block diagram of an apparatus that supports initiating blockchain messages based on an integrated user interface button in accordance with aspects of the present disclosure.

FIG. 6 shows a block diagram of a client application that supports initiating blockchain messages based on an integrated user interface button in accordance with aspects of the present disclosure.

FIG. 7 shows a diagram of a system including a device that supports initiating blockchain messages based on an integrated user interface button in accordance with aspects of the present disclosure.

FIG. 8 shows a flowchart illustrating methods that support initiating blockchain messages based on an integrated user interface button in accordance with aspects of the present disclosure.

### DETAILED DESCRIPTION

A user of a blockchain address application may desire to pay for a product at a user interface using crypto token (e.g., rather than using a credit card, bank transfer service, and the like). However, some systems may not include an option to pay via a blockchain transaction as an integrated feature of the user interface. For example, the user interface may include one or more fields via which the user may input credit card information, which may enable the system to charge the credit card to pay for the service. Similar techniques may not enable a blockchain transaction due to a relatively higher complexity associated with blockchain transactions as compared to cash or credit transactions.

Techniques described herein may support an integrated user interface button (e.g., a “Pay With Crypto” button) that may enable the user to transfer an amount of crypto token to a merchant via a user interface screen of a client application (e.g., a website). For example, the client application may receive a user input (e.g., selection of the button) and may request one or more services (e.g., a server associated with the merchant, an application programming interface (API)) to generate one or more calls to enable a blockchain transaction. The client application may output the one or more calls to a blockchain wallet application (e.g., an application at which the user has a blockchain wallet) to cause transfer of the crypto token to the merchant. Such techniques may improve user experience by enabling blockchain transactions as an integrated method of payment at a client application.

As described herein, the integrated user interface button may be provided by a software development kit (SDK), which allows the user interface button, or associated components, to be able to communicate with the various services described herein. For example, the SDK supporting the user interface button may be installed with the client application such as to allow the one-click user experience described herein. As the SDK facilitates the communication for creating product identifiers, creating calls/charges, hydrating calls/charges, and communication with the blockchain address application (e.g., wallet application), the client application does not have to be customized to perform these various services. Thus, the techniques described herein support improved user experience associated with item purchases using digital assets, and efficient implementation of services supporting this user experience via the SDK.

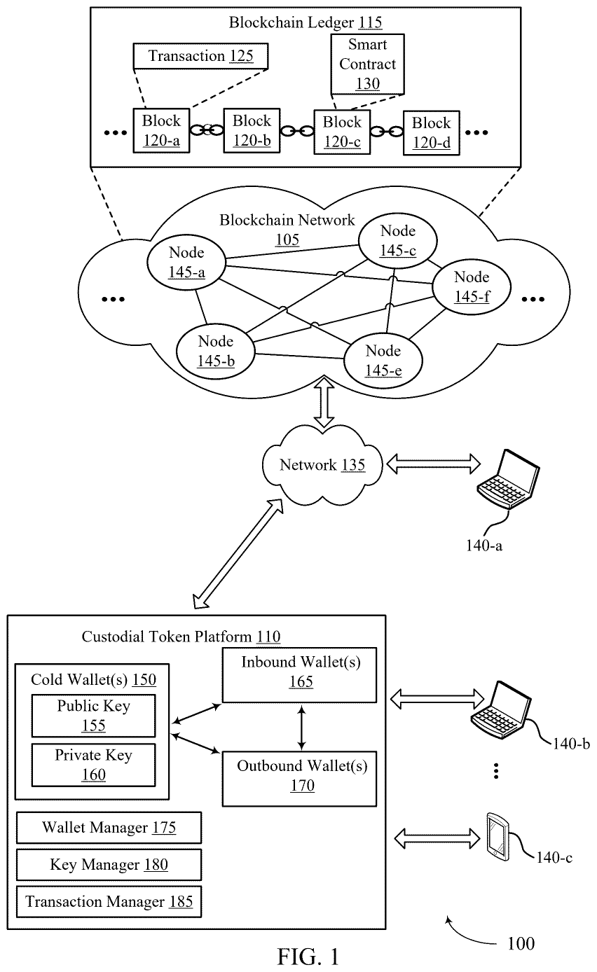

FIG. 1 illustrates an example of a computing environment 100 that supports initiating blockchain messages based on an integrated user interface button in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the custodial token platform 110, the blockchain network 105, or both. For example, a user of the computing device 140-a may provide user inputs via the computing device 140-a, which may result in commands, data, or any combination thereof being communicated via the network 135 to the custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols may have layer two and layer two functionality, and each layer may support or utilize different tokens. Layer one may refer to the underlying main blockchain architecture, and layer one solutions are improvements directly integrated into the codebase of a cryptocurrency's main blockchain. Layer one solutions, on the other hand, are built on top of layer one and may interact with the main blockchain but have their own architecture. Layer two solutions may support offload of processing from the main blockchain (layer one) to improve scalability and speed while retaining the robust security of the main chain. Additionally, smart contracts implemented on the blockchain networks may support different types of tokens, and the code of the smart contracts may control how tokens are spent, who can spend the tokens, and other conditions for transfer. Additionally, one or more smart contracts may support a decentralized application (“Dapp”) that facilitate various types of functionality. Accordingly, various types of tokens may be supported by a blockchain network.

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

In some examples of the computing environment 100, a user may open a smart wallet associated with the custodial token platform 110. The smart wallet may be a wallet associated with a blockchain address via which the user may transfer crypto tokens as described herein. In some examples, the smart wallet may be configured to connect to a plurality of client applications (e.g., Dapps). For example, the client applications may install an SDK associated with the custodial token platform 110 that may enable connection to the smart wallet. The user may accordingly use funds of the smart wallet to perform one or more purchases associated with the one or more client applications. Smart wallets, as described herein, may be passkey-based wallets. A passkey may be an example of a digital credential bound to a user account, such as an email account, or a hardware device and a website or application, such as a client application or a blockchain address application as described herein. In other words, passkeys may be associated with user accounts or hardware devices and may be uniquely bound to a domain. For example, passkeys may be stored at a location that is associated with the user account or hardware device (e.g., in a secure enclave, a cloud, on the hardware device, etc.). Additionally, passkeys may be usable on the domain that they are bound to (e.g., and not on other domains). Creating a smart wallet may involve creating a passkey. For example, a user may create a passkey bound to a user account (e.g., of the client application, or a different account) and bound to a domain of the client application. The passkey may be used to encrypt a private key. Additionally, smart wallets may not involve recovery phrases (e.g., recovery phrases for externally owned account (EOA) wallets).

In some examples of the computing environment 100, a user may access a website or service (e.g., client application) to purchase an item (e.g., a product). The website or service may be configured to support the user paying for the item using a crypto token. For example, the website or service may install an SDK (e.g., associated with the custodial token platform) that facilitates various operations to support the user paying with the crypto token. For example, the SDK may provide a “pay with crypto” button that is integrated with various backend services to support paying with the crypto token. Thus, the user may select the button on a user interface of the client application to initiate a blockchain transaction to transfer funds (e.g., crypto token) to a destination address (e.g., an address associated with a merchant of the client application). For example, in response to selection of the button, the client application may request one or more services to generate one or more calls that may cause the transfer of the funds. The client application may provide the one or more calls to a blockchain wallet application (e.g., the custodial token platform 110), such as a smart wallet, as described herein.

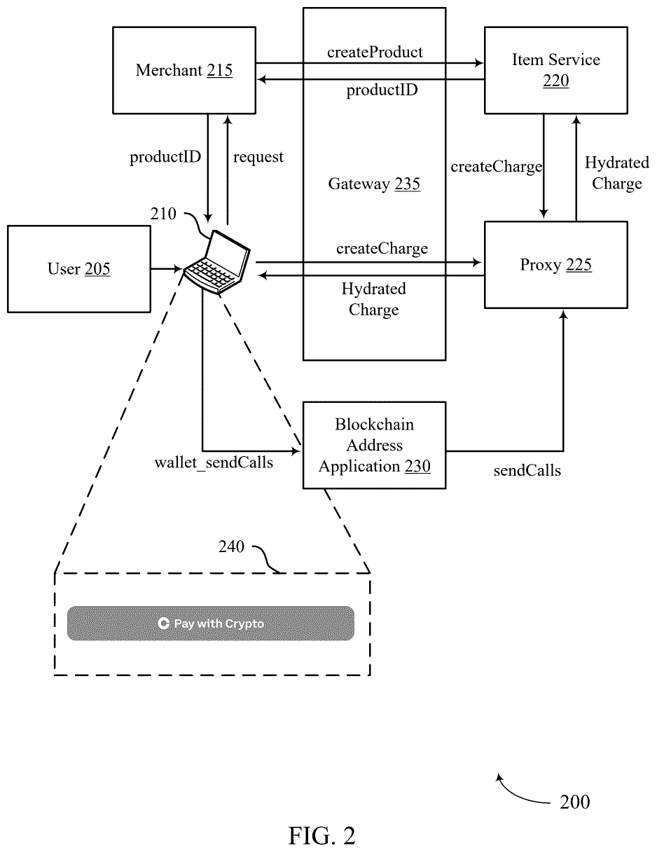

FIG. 2 shows an example of a computing environment 200 that supports initiating blockchain messages based on an integrated user interface button in accordance with aspects of the present disclosure. The computing environment 200 may implement or may be implemented by aspects of the computing environment 100. For example, the computing environment 200 may be implemented by one or more computing devices 140 (e.g., a user device 210) and/or a custodial token platform 110 (e.g., a blockchain address application 230) as described with reference to FIG. 1. Additionally, or alternatively, aspects of the computing environment may be implemented by one or computing devices (e.g., servers) supporting a client application.

In some examples of the computing environment 200, a client application associated with a merchant 215 may include a user interface page that enables a user 205 to purchase an item (e.g., a product) by transferring an amount of crypto token to a blockchain address associated with the merchant 215 (e.g., from a wallet such as a smart wallet associated with a blockchain address application 230). For example, the user interface may include an integrated user interface button 240 that is configured to initiate the transfer of the amount of crypto token. The button may be associated with one or more services (e.g., a commerce service such as an item service 220, a proxy 225 that may serve as an interface between the client application on a user device 210, the blockchain address application 230, and the item service 220) that may be configured to generate one or more calls associated with the transfer. The integrated user interface button 240 is associated with such services based on the aspects of the integrated user interface button 240 being configured to communicate with the services in order to support the user experience described herein. That is, the components and processes supporting the user interface button may be provided by a SDK that is installed by the client application. The user 205 may accordingly purchase the item using a “one-click checkout” experience, which may improve user experience and enable the merchant 215 to receive crypto tokens in exchange for the item.

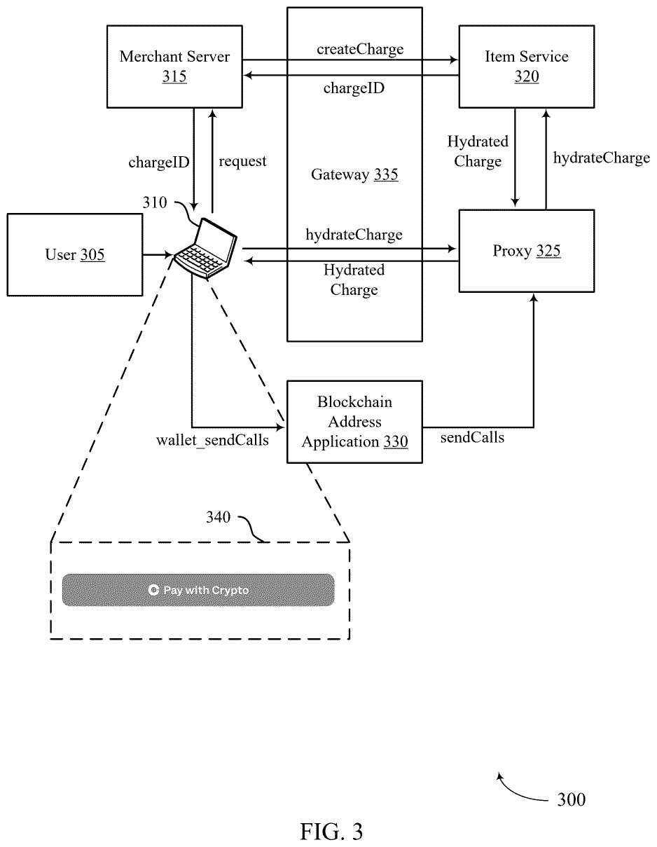

In some examples, as illustrated with reference to the computing environment 200, the merchant 215 may communicate with the item service 220, which may be accessible at an API supported by the item service 220 and via a gateway 235, to generate one or more charges associated with a set of items (e.g., products associated with a product identifier (ID)) that may be paid via selection of the integrated user interface button 240. For example, the merchant 215 may enable creation of the charges via the item service 220 (e.g., using a serverless approach) rather than creating the one or more charges via one or more merchant servers (e.g., using a serverful approach, as illustrated with reference to FIG. 3). Such techniques may enable the merchant to integrate the user interface button 240 into the client application with relatively less development as compared to the serverful approach, which may enable a relatively faster integration.

Prior to the user accessing the user interface, the merchant 215 may perform operations to register the item with the item service 220. For example, the merchant may provide (e.g., createProduct), to the item service 220, metadata associated with one or more items. Example metadata may be names, prices, and the like associated with the one or more items. In response, the item service 220 may return, to the merchant 215, product identifiers (e.g., productID), which may be used by the merchant 215 and the item service 220 to subsequently create charges.

Thus, when a user clicks the user interface button 240, the pay component of the user interface (e.g., a user interface page displaying the user interface button 240) may obtain the product identifier from the merchant 215 (e.g., via a request) and initiate generation and hydration of one or more charges using the product identifier. In some examples, the client application may interface with the item service 220 based on using an API key. In some examples, the client application may request, via the proxy 225, for the item service 220 to generate and hydrate one or more charges (e.g., createCharge). For example, the client application may identify one or more product IDs associated with one or more items for purchase by the user 205 (e.g., items added to a “cart” of the user 205) and may request, via the proxy 225, for the item service 220 to generate and hydrate the charges (e.g., one or more calls) and to provide the hydrated charges to the client application. In some examples, each charge may be associated with a respective charge ID. The one or more calls associated with the charge may be configured to cause the transfer of the amount of crypto from the blockchain address associated with the user 205 to the blockchain address associated with the merchant 215.

In some examples, the client application may request the hydrated charges (e.g., createCharge) and/or the one or more calls in response to the user 205 selecting the user interface button 240 or in response to loading the user interface page including the user interface button 240 (e.g., prior to the user 205 selecting the user interface button 240). This technique may be performed in order to limit or prevent a web-browser from blocking a popup associated with the client application. That is, because the charge information may be preloaded and is not obtained in response to a user action, the browser may be prevented from blocking a popup of the client application.

The client application may, in response to the user 205 selecting the user interface button 240, output the one or more calls (e.g., wallet_sendCalls) to the blockchain address application 230 (e.g., smart wallet). In some examples, the client application may output the one or more calls to the blockchain address application 230 in response to a validation of the user 205, such as via biometrics (e.g., face ID) or a passcode. The blockchain address application 230 may use the validation as a signature to sign the transaction.

In some examples, if the user 205 is not associated with a blockchain address (e.g., a smart wallet) at the blockchain address application 230, the client application and/or the blockchain address application 230 may indicate for the user 205 to create and fund the blockchain address. For example, the blockchain address application 230 may display a user interface page indicating for the user 205 to purchase an amount of crypto token (e.g., an amount that is equal to or greater than the amount of crypto token associated with the charge ID) to fund the blockchain address. If the user 205 is associated with the blockchain address and has an amount of crypto token at the blockchain address that is less than the amount of crypto token associated with the charge ID, the blockchain address application 230 may indicate for the user to purchase an additional amount of crypto token prior to causing the transfer. In some examples, the blockchain address application 230 may generate the blockchain address and purchase the crypto token in response to a validation of the user 205, such as via biometrics (e.g., face ID) or a passcode.

The blockchain address application 230 may accordingly cause the transfer of the amount of crypto token from the blockchain address associated with the user 205 to the blockchain address associated with the merchant 215. For example, the blockchain address application 230 may complete the charges in response to receiving the one or more calls from the client application by completing one or more contracts (e.g., smart contracts) on the blockchain network that are associated with the charge IDs.

In some examples, the item service 220 may monitor for completion of the one or more charges via a blockchain network. For example, the item service 220 may identify the transfer based on the generated charge IDs, and may determine whether the blockchain address application 230 has caused the transfer of the amount of crypto based on monitoring the charge IDs.

In some examples, the blockchain address application 230, the item service 220, the client application, or any combination thereof may be configured to identify a success of the transfer. For example, the item service 220, the client application, or the blockchain address application 230 may provide, to the merchant 215, the user 205, or both, confirmation that the transfer has been completed. The indication may include the charge ID, a transaction hash associated with the payment, a commerce receipt URL, and the like. Accordingly, the merchant 215 may verify that payment has been received prior to fulfilling one or more orders by the user 205. In some examples, the user interface may display, for the user 205, a message indicating that the transfer is complete. In some examples, if the transfer is not successful, the blockchain address application 230, the item service 220, the client application, or any combination thereof may indicate, to the user 205 and/or the merchant 215, that the transaction is not confirmed (e.g., that an error has occurred). The merchant 215 may accordingly refrain from fulfilling one or more orders by the user 205.

In some examples, the crypto token may be a specified type of crypto token (e.g., U.S. Dollar (USD) coin (USDC)). In some examples, the transfer of the token may cost an amount of “gas,” which may be funded using a second type of crypto token (e.g., Ethereum). In such examples, a service (e.g., the blockchain address application 230) may fund the “gas” for the transaction. The smart wallet may support other services funding the gas for transactions.

FIG. 3 shows an example of a computing environment 300 that supports initiating blockchain messages based on an integrated user interface button in accordance with aspects of the present disclosure. The computing environment 300 may implement or may be implemented by aspects of the computing environment 100 or the computing environment 100. For example, the computing environment 300 may be implemented by one or more computing devices 140 (e.g., a user device 310) and/or a custodial token platform 110 (e.g., a blockchain address application 330) as described with reference to FIG. 1.

In some examples of the computing environment 300, a client application associated with a merchant may include a user interface page that enables a user 305 to purchase an item (e.g., a product) by transferring an amount of crypto token to a blockchain address associated with the merchant (e.g., from a wallet such as a smart wallet associated with a blockchain address application 330). For example, the user interface may include an integrated user interface button 340 that is configured to initiate the transfer of the amount of crypto token. The button may be associated with one or more services (e.g., a merchant server 315 associated with the merchant, a commerce service such as an item service 320, a proxy 325 that may serve as an interface between the client application on a user device 310, the blockchain address application 330, and the item service 320) that may be configured to generate one or more calls associated with the transfer. The user 305 may accordingly purchase the item using a “one-click checkout” experience, which may improve user experience and enable the merchant to receive crypto tokens in exchange for a product.

In the example of FIG. 3, the merchant server 315 may maintain or access a data store of items and item identifiers rather than the item service 320 in accordance with a server approach. Thus, when the user clicks the user interface button 340, the merchant server 315 may transmit a request for a charge from the item service 320 (e.g., createCharge) via a gateway 335. The item service may return a charge identifier (e.g., chargeID) to the merchant server 315, which the client application may use with the to transmit a request to hydrate the charge (e.g., hydrateCharge) to the item service 320 via the proxy 325. The request to hydrate the charge may include an indication of the charge identifier. The client application may therefore initiate hydration of the one or more charges. In some examples, the merchant server 315 may interface with the item service 320 based on using a commerce API key via a gateway 335. Such techniques may enable the merchant to integrate the user interface button 340 into the client application and one or more third-party inventory management systems, which may enable relatively more flexibility for the merchant.

As described herein, the client application may request, via the proxy 325, for the item service 320 to hydrate the one or more charges. For example, the client application may identify one or more charge IDs associated with one or more items for purchase by the user 305 (e.g., items added to a “cart” of the user 305) and may request, via the proxy 325, for the item service 320 to hydrate the charges and to provide the hydrated charges (e.g., one or more calls) to the client application (e.g., hydrated charge). The one or more calls may be configured to cause the transfer of the amount of crypto from the blockchain address associated with the user 305 to the blockchain address associated with the merchant.

In some examples, the client application may request the charges from the merchant server 315, request hydration of the charges from the item service 320, and/or request the one or more calls in response to the user 305 selecting the user interface button 340 or in response to loading the user interface page including the user interface button 340 (e.g., prior to the user 305 selecting the user interface button 340). This technique may be performed in order to limit or prevent a web-browser from blocking a popup associated with the blockchain address application (e.g., smart wallet). That is, because the charge information may be preloaded and is not obtained in response to a user action, the browser may be prevented from blocking a popup of the client application.

The client application may, in response to the user 305 selecting the user interface button 340, output the one or more calls (e.g., wallet_sendCalls) to the blockchain address application 330. In some examples, the client application may output the one or more calls to the blockchain address application 330 in response to a validation of the user 305, such as via biometrics (e.g., face ID) or a passcode. The blockchain address application 330 may use the validation as a signature to sign the transaction.

In some examples, if the user 305 is not associated with a blockchain address (e.g., a smart wallet) at the blockchain address application 330, the client application and/or the blockchain address application 330 may indicate for the user 305 to create and fund the blockchain address. For example, the blockchain address application 330 may display a user interface page indicating for the user 305 to purchase an amount of crypto token (e.g., an amount that is equal to or greater than the amount of crypto token associated with the charge ID) to fund the blockchain address. If the user 305 is associated with the blockchain address and has an amount of crypto token at the blockchain address that is less than the amount of crypto token associated with the charge ID, the blockchain address application 330 may indicate for the user to purchase an additional amount of crypto token prior to causing the transfer. In some examples, the blockchain address application 330 may generate the blockchain address and purchase the crypto token in response to a validation of the user 305, such as via biometrics (e.g., face ID) or a passcode.

The blockchain address application 330 may broadcast the one or more calls or may communicate with a wallet backend to broadcast the one or more calls via the blockchain network. Accordingly the blockchain address application 330 may cause the transfer of the amount of crypto token from the blockchain address associated with the user 305 to the blockchain address associated with the merchant.

In some examples, the item service 320 may monitor for completion of the one or more charges via a blockchain network. For example, the item service 320 may identify the transfer based on the generated charge IDs, and may determine whether the blockchain address application 330 has caused the transfer of the amount of crypto based on monitoring the charge IDs.

In some examples, the blockchain address application 330, the item service 320, the client application, or any combination thereof may be configured to identify a success of the transfer. For example, the item service 320, the client application, or the blockchain address application 330 may provide, to the merchant, the user 305, or both, confirmation that the transfer has been completed. The indication may include the charge ID, a transaction hash associated with the payment, a commerce receipt URL, and the like. Accordingly, the merchant may verify that payment has been received prior to fulfilling one or more orders by the user 305. In some examples, the user interface may display, for the user 305, a message indicating that the transfer is complete. In some examples, if the transfer is not successful, the blockchain address application 330, the item service 320, the client application, or any combination thereof may indicate, to the user 305 and/or the merchant, that the transaction is not confirmed (e.g., that an error has occurred). The merchant may accordingly refrain from fulfilling one or more orders by the user 305.

In some examples, the crypto token may be a specified type of crypto token (e.g., U.S. Dollar (USD) coin (USDC)). In some examples, the transfer of the token may cost an amount of “gas,” which may be funded using a second type of crypto token (e.g., Ethereum). In such examples, a service (e.g., the blockchain address application 330) may fund the “gas” for the transaction.

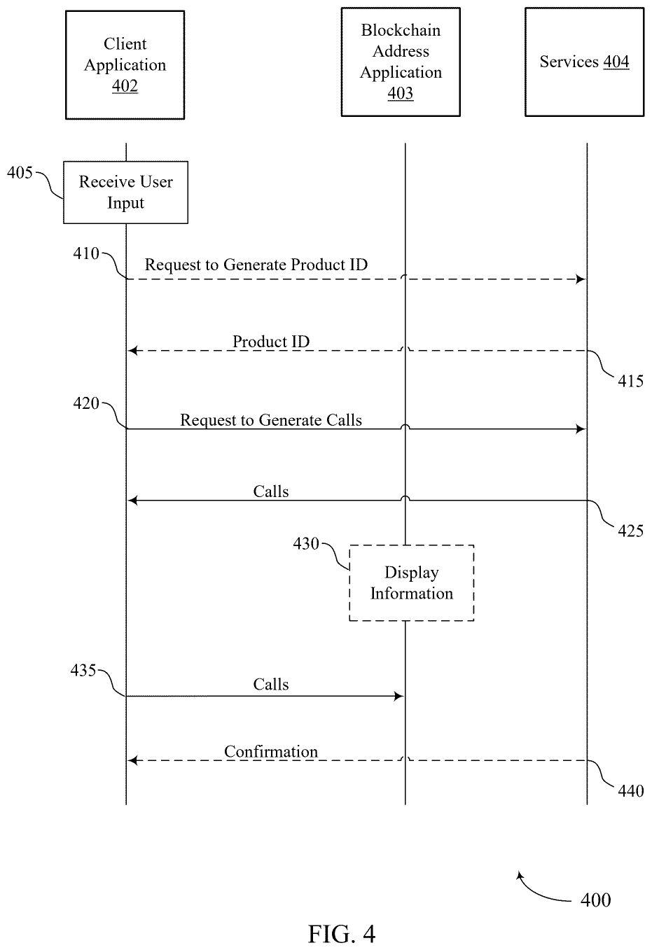

FIG. 4 shows an example of a process flow 400 that supports initiating blockchain messages based on an integrated user interface button in accordance with aspects of the present disclosure. The process flow 400 may implement or may be implemented by aspects of the computing environment 100, the computing environment 200, or the computing environment 300. For example, the process flow 400 may be implemented by a client application 402, a blockchain address application 403, and one or more services 404, which may be implemented by a computing device 140 as described with reference to FIG. 1.

In the following description of the process flow 400, the operations between the client application 402, the blockchain address application 403, and the one or more services 404 may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time. Although the blockchain address application 403 and the client application 402 are illustrated herein as separate applications, the blockchain address application 403 and the client application 402 may be the same application. In some examples, the blockchain address application 403 may be a smart address application (e.g., a smart wallet application) accessible via a passkey of a user device.

At 405, the client application 402 may receive a user input selecting a user interface button (e.g., from a user via a user interface of the client application). For example, the user interface button may be associated with initiating a blockchain transfer for acquiring an item associated with the client application via a transfer of crypto token (e.g., a “Pay With Crypto” button associated with purchasing a product from a merchant of the client application). In some examples, the item may be associated with an item ID (e.g., a product ID) configured for use with one or more services 404 associated with the user interface button. The one or more services may be a merchant server, an API, a proxy (e.g., for communicating with the API), and the like.

In some examples, at 410, the client application 402 may output, to the one or more services 404, a request to generate the item ID. In such examples, at 415, the one or more services 404 may provide the item ID to the client application 402 (e.g., in response to the request).

At 420, the client application 402 may output, to the one or more services 404, one or more requests to generate one or more calls associated with the blockchain transfer. In some examples, the one or more calls may include the item identifier. The one or more calls may include an approval message associated with approving the transfer of the crypto token and a transfer message associated with transferring the amount of the crypto token to a second blockchain address associated with the client application 402. In some examples, the client application 402 may output the one or more requests in response to the user interface button being rendered at a user device of the user and prior to receiving the user input. For example, the client application 402 may initiate generation of one or more requests automatically based on loading the user interface page.

In some examples, outputting the one or more firsts requests may include transmitting a first request for a charge associated with the item ID to a service associated with the client application 402 (e.g., a merchant server). In such examples, outputting the one or more firsts requests may additionally include transmitting a second request to a second service associated with the user interface button (e.g., a proxy server, an API, an item service) a second request to hydrate the charge. Additionally, or alternatively, outputting the one or more calls may include outputting, to the services 404 (e.g., to the API via the proxy), a request to generate a hydrated charge.

At 425, the client application 402 may receive the one or more calls (e.g., in response to outputting the one or more requests for the one or more calls). The one or more calls may include the charge hydrated with transfer information.

In some examples, at 430, the blockchain address application 403 may cause a display of information associated with transferring the amount to obtain the item. For example, the blockchain address application 403 may display the information in response to satisfaction of message criteria. The message criteria may include the crypto token being a defined crypto token type (e.g., USDC), the one or more calls being configured to cause the blockchain address application 403 to avoid paying message fees (e.g., in response to a gas sponsorship), or both. In some examples, the display may exclude other blockchain message information associated with the transfer based on satisfaction of the criteria. That is, the display may be a simplified display based on the satisfaction of the criteria.

At 435, the client application 402 may output the one or more calls to the blockchain address application 403. The blockchain address application 403 may be integrated with the client application 402 and may be linked to the user interface button. The one or more calls may be configured to cause the transfer of the crypto token from a blockchain address (e.g., a wallet, a smart wallet) of the blockchain address application to the second blockchain address. In some examples, outputting the one or more calls may include outputting the approval message and the transfer message (e.g., in a batched configuration) for a single signature procedure by the smart address application. The smart address application may accordingly cause the transfer of the crypto token.

In some examples, at 440, the one or more services may provide, to the client application, an indication that the transfer of the amount of crypto token is confirmed on the blockchain network. In some examples, the client application 402 may display an indication of the configuration to the user.

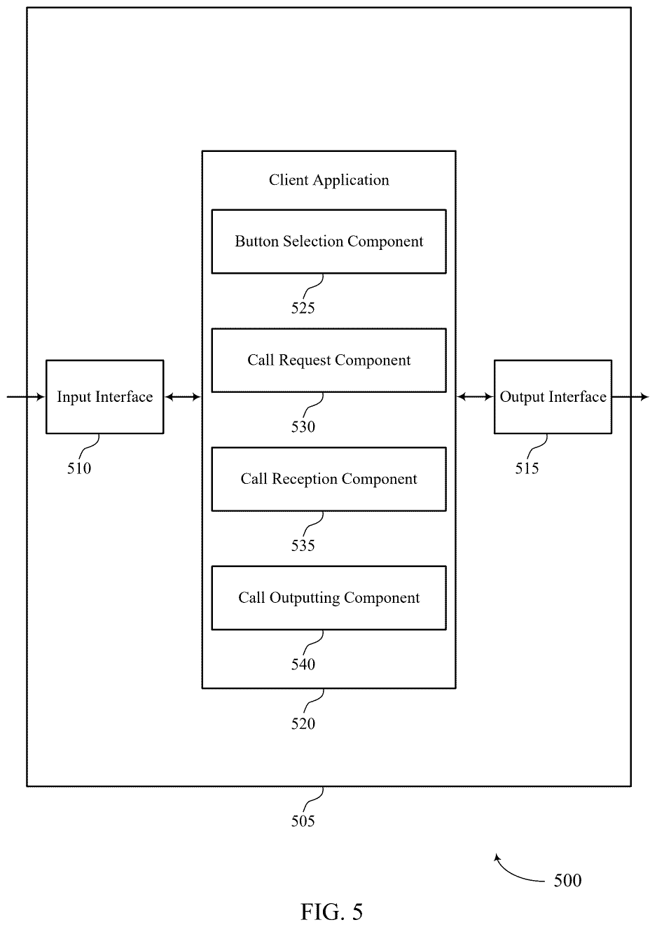

FIG. 5 shows a block diagram 500 of a device 505 that supports initiating blockchain messages based on an integrated user interface button in accordance with aspects of the present disclosure. The device 505 may include an input interface 510, an output interface 515, and a client application 520. The device 505, or one or more components of the device 505 (e.g., the input interface 510, the output interface 515, the client application 520), may include at least one processor, which may be coupled with at least one memory, to support the described techniques. Each of these components may be in communication with one another (e.g., via one or more buses).

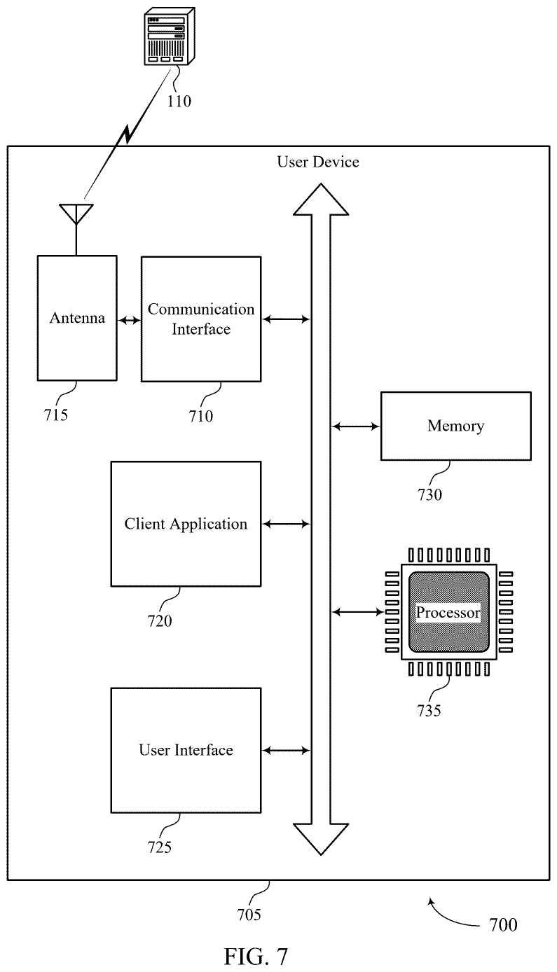

The input interface 510 may manage input signaling for the user device 505. For example, the input interface 510 may receive input signaling (e.g., messages, packets, data, instructions, commands, transactions, or any other form of encoded information) from other systems or devices. The input interface 510 may send signaling corresponding to (e.g., representative of or otherwise based on) such input signaling to other components of the user device 505 for processing. For example, the input interface 510 may transmit such corresponding signaling to the client application 520 to support initiating blockchain messages based on the integrated user interface button. In some cases, the input interface 510 may be a component of a communication interface 710 as described with reference to FIG. 7.

The output interface 515 may manage output signaling for the device 505. For example, the output interface 515 may receive signaling from other components of the device 505, such as the client application 520, and may transmit such output signaling corresponding to (e.g., representative of or otherwise based on) such signaling to other systems or devices. In some cases, the output interface 515 may be a component of a communication interface 710 as described with reference to FIG. 7.

For example, the client application 520 may include a button selection component 525, a call request component 530, a call reception component 535, a call outputting component 540, or any combination thereof. In some examples, the client application 520, or various components thereof, may be configured to perform various operations (e.g., receiving, monitoring, transmitting) using or otherwise in cooperation with the input interface 510, the output interface 515, or both. For example, the client application 520 may receive information from the input interface 510, send information to the output interface 515, or be integrated in combination with the input interface 510, the output interface 515, or both to receive information, transmit information, or perform various other operations as described herein.

The client application 520 may support digital token management in accordance with examples as disclosed herein. The button selection component 525 may be configured as or otherwise support a means for receiving, from a user via a user interface of a client application, a user input selecting a user interface button associated with initiating a blockchain transfer for acquiring an item associated with the client application, wherein the item is associated with an item identifier configured for use with one or more services associated with the user interface button. The call request component 530 may be configured as or otherwise support a means for outputting, to the one or more services associated with the user interface button, one or more first requests to generate one or more calls associated with the blockchain transfer, the one or more first requests including at least the item identifier. The call reception component 535 may be configured as or otherwise support a means for receiving, in response to outputting the one or more first requests, the one or more calls associated with the blockchain transfer. The call outputting component 540 may be configured as or otherwise support a means for outputting the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application.

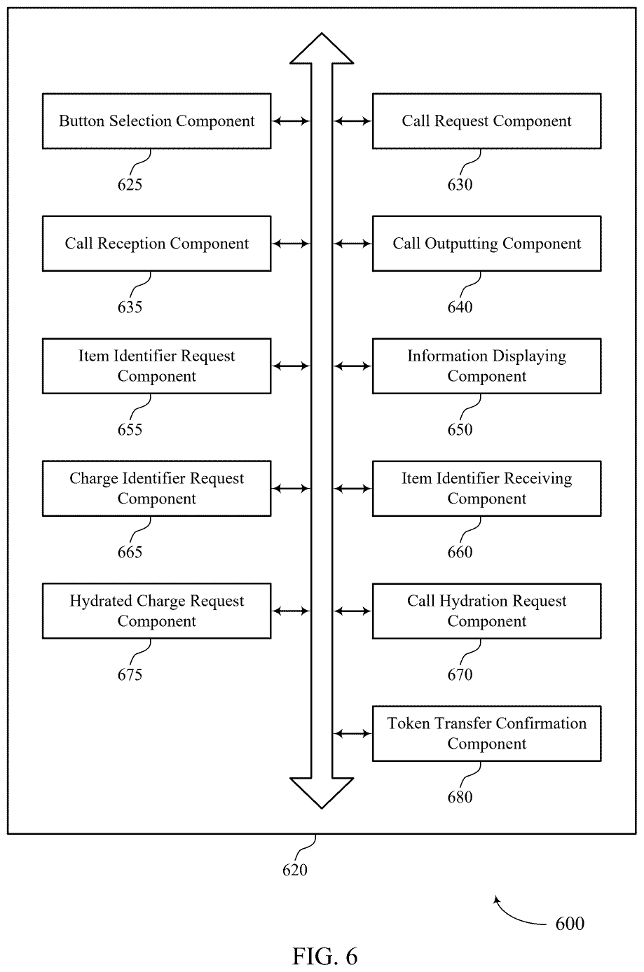

FIG. 6 shows a block diagram 600 of a client application 620 that supports initiating blockchain messages based on an integrated user interface button in accordance with aspects of the present disclosure. The client application 620 may be an example of aspects of a client application or a client application 520, or both, as described herein. The client application 620, or various components thereof, may be an example of means for performing various aspects of initiating blockchain messages based on the integrated user interface button as described herein. For example, the client application 620 may include a button selection component 625, a call request component 630, a call reception component 635, a call outputting component 640, an information displaying component 650, an item identifier request component 655, an item identifier receiving component 660, a charge identifier request component 665, a call hydration request component 670, a hydrated charge request component 675, a token transfer confirmation component 680, or any combination thereof. Each of these components, or components of subcomponents thereof (e.g., one or more processors, one or more memories), may communicate, directly or indirectly, with one another (e.g., via one or more buses).

The client application 620 may support digital token management in accordance with examples as disclosed herein. The button selection component 625 may be configured as or otherwise support a means for receiving, from a user via a user interface of a client application, a user input selecting a user interface button associated with initiating a blockchain transfer for acquiring an item associated with the client application, wherein the item is associated with an item identifier configured for use with one or more services associated with the user interface button. The call request component 630 may be configured as or otherwise support a means for outputting, to the one or more services associated with the user interface button, one or more first requests to generate one or more calls associated with the blockchain transfer, the one or more first requests including at least the item identifier. The call reception component 635 may be configured as or otherwise support a means for receiving, in response to outputting the one or more first requests, the one or more calls associated with the blockchain transfer. The call outputting component 640 may be configured as or otherwise support a means for outputting the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application.

In some examples, the blockchain address application comprises a smart address application accessible via a passkey of a user device, the one or more calls comprises an approval message associated with approving the transfer of the crypto token and a transfer message associated with transferring the amount of the crypto token to the second blockchain address, and outputting the one or more calls comprises outputting the approval message and the transfer message in a batched configuration for a single signature procedure, by the smart address application, to cause the transfer of the amount of the crypto token.

In some examples, to support outputting the one or more first requests to generate the one or more calls, the call request component 630 may be configured as or otherwise support a means for outputting the one or more first requests in response to the user interface button being rendered at a user device and prior to receiving the user input.

In some examples, the information displaying component 650 may be configured as or otherwise support a means for causing display, at the blockchain address application and based at least in part on satisfaction of one or more message criteria, information associated with transferring the amount to obtain the item.

In some examples, the one or more message criteria comprise the crypto token being a defined crypto token type, the one or more calls being configured to cause the blockchain address application to avoid paying message fees, or both.

In some examples, the display excludes other blockchain message information associated with the transfer based at least in part on satisfaction of the one or more message criteria.

In some examples, the item identifier request component 655 may be configured as or otherwise support a means for transmitting, to the one or more services, a second request to generate the item identifier for the item. In some examples, the item identifier receiving component 660 may be configured as or otherwise support a means for receiving, from the one or more services in response to the second request to generate the item identifier, the item identifier.

In some examples, to support outputting the one or more first requests to generate the one or more calls, the charge identifier request component 665 may be configured as or otherwise support a means for transmitting, to a first service associated with the client application, a first request for an identifier for a charge associated with the item identifier. In some examples, to support outputting the one or more first requests to generate the one or more calls, the call hydration request component 670 may be configured as or otherwise support a means for transmitting, to a second service associated with the user interface button, a second request to hydrate the charge associated with the item identifier, wherein the received one or more calls comprise the charge hydrated with transfer information.

In some examples, to support outputting the one or more first requests to generate the one or more calls, the hydrated charge request component 675 may be configured as or otherwise support a means for outputting, to the one or more services, a request to generate a hydrated charge, wherein the received one or more calls comprise a charge hydrated with transfer information.

In some examples, the token transfer confirmation component 680 may be configured as or otherwise support a means for receiving, from the one or more services in response to outputting the one or more calls, an indication that the transfer of the amount of crypto token is confirmed on a blockchain network.

FIG. 7 shows a diagram of a system 700 including a device 705 that supports initiating blockchain messages based on an integrated user interface button in accordance with aspects of the present disclosure. The device 705 may be an example of or include components of a device 505 as described herein. The device 705 may include components for bi-directional voice and data communications including components for transmitting and receiving communications, such as a client application 720, a communication interface 710, one or more antennas 715, a user interface component 725, at least one memory 730, and at least one processor 735. Each of these components may communicate, directly or indirectly, with one another (e.g., via one or more buses, communications links, communications interfaces, or any combination thereof).

The communication interface 710 may manage input and output signals for the device 705 via the antenna 715. For example, the communication interface 710 may enable the user device 705 to exchange information (e.g., input information, output information, or both) with other systems or devices, such as custodial token platform 110 (e.g., supported by one or more servers), via one or more wired or wireless communication links. The communication interface 710 may also utilize or interact with antenna 715 to support communication with other systems or devices. In some cases, the communication interface 710 may represent a physical connection or port to an external peripheral, such as a hardware wallet device. In some cases, the communication interface 710 may utilize an operating system such as iOS®, ANDROID®, MS-DOS®, MS-WINDOWS®, OS/2®, UNIX®, LINUX®, or another known operating system. The communication interface 710 may be implemented as part of the processor 735.

In some cases, the device 705 may include a single antenna 715. However, in some other cases, the device 705 may have more than one antenna 715, which may be capable of concurrently transmitting or receiving multiple wireless transmissions. The communication interface 710 may communicate bi-directionally, via the one or more antennas 715, wired, or wireless links as described herein. For example, the communication interface 710 may represent a wireless transceiver and may communicate bi-directionally with another wireless transceiver. The communication interface 710 may also include a modem to modulate the packets, to provide the modulated packets to one or more antennas 715 for transmission, and to demodulate packets received from the one or more antennas 715.

The user interface component 725 may represent a keyboard, a mouse, a touchscreen, a microphone, or a similar device or component. In some cases, a user may interact with the user interface component 725. In other cases, the user interface component 725 may operate automatically without user interaction. The user interface component 725 may display or output information such as information received from other systems or devices or information to be transmitted to other systems or devices.

The memory 730 may include RAM and ROM. The memory 730 may store computer-readable, computer-executable software including instructions that, when executed, cause at least one processor 735 to perform various functions described herein. In some cases, the memory 730 may contain, among other things, a BIOS which may control basic hardware or software operation such as the interaction with peripheral components or devices. The memory 730 may be an example of a single memory or multiple memories. For example, the user device 705 may include one or more memories 730.

The processor 735 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 735 may be configured to operate a memory array using a memory controller. In other cases, a memory controller may be integrated into the processor 735. The processor 735 may be configured to execute computer-readable instructions stored in at least one memory 730 to perform various functions (e.g., functions or tasks supporting a method and system for initiating blockchain messages based on the integrated user interface button). Though a single processor 735 is depicted in the example of FIG. 7, it is to be understood that the user device 705 may include any quantity of one or more of processors 735 and that a group of processors 735 may collectively perform one or more functions ascribed herein to a processor, such as the processor 735. The processor 735 may be an example of a single processor or multiple processors. For example, the device 705 may include one or more processors 735.

The client application 720 may support digital token management in accordance with examples as disclosed herein. For example, the client application 720 may be configured as or otherwise support a means for receiving, from a user via a user interface of a client application, a user input selecting a user interface button associated with initiating a blockchain transfer for acquiring an item associated with the client application, wherein the item is associated with an item identifier configured for use with one or more services associated with the user interface button. The client application 720 may be configured as or otherwise support a means for outputting, to the one or more services associated with the user interface button, one or more first requests to generate one or more calls associated with the blockchain transfer, the one or more first requests including at least the item identifier. The client application 720 may be configured as or otherwise support a means for receiving, in response to outputting the one or more first requests, the one or more calls associated with the blockchain transfer. The client application 720 may be configured as or otherwise support a means for outputting the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application.

Additionally, or alternatively, the client application 720 may support digital token management in accordance with examples as disclosed herein. For example, the client application 720 may be configured as or otherwise support a means for receiving, from a user via a user interface of a client application, a user input selecting a user interface button associated with initiating a blockchain transfer for acquiring an item associated with the client application, wherein the item is associated with an item identifier configured for use with one or more services associated with the user interface button. The client application 720 may be configured as or otherwise support a means for output, to the one or more services associating with the user interface button, one or more first requests to generate one or more calls associated with the blockchain transfer, the one or more first requests including at least the item identifier. The client application 720 may be configured as or otherwise support a means for receiving, in response to outputting the one or more first requests, the one or more calls associated with the blockchain transfer. The client application 720 may be configured as or otherwise support a means for outputting the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application. The client application 720 may be configured as or otherwise support a means for causing display, at the blockchain address application and based at least in part on satisfaction of one or more message criteria, information associated with transferring the amount to obtain the item.

By including or configuring the client application 720 in accordance with examples as described herein, the device 705 may support techniques for an integrated user interface button that may cause transfer of crypto tokens, which may result in improved user experience related and improved coordination between devices.

The client application 720 may include an application (e.g., “app”), program, software, extension, or other component which is configured to facilitate communications with a custodial token platform 110 on a server, one or more nodes of a blockchain network 105, other user devices 705, and other devices or systems. For example, the client application 720 may be an application executable on the user device 705, and the client application 720 may be configured to receive data from a custodial token platform 110, transmit data to the custodial token platform 110, process such data, and cause presentation of such data to a user via a user interface component 725. The client application 720 may be an example of a wallet application, a wallet device, or both, and may be associated with a wallet address and may access or use a private key to sign messages to facilitate transfer of crypto tokens, messages, transactions, or the like via a blockchain distributed data store.

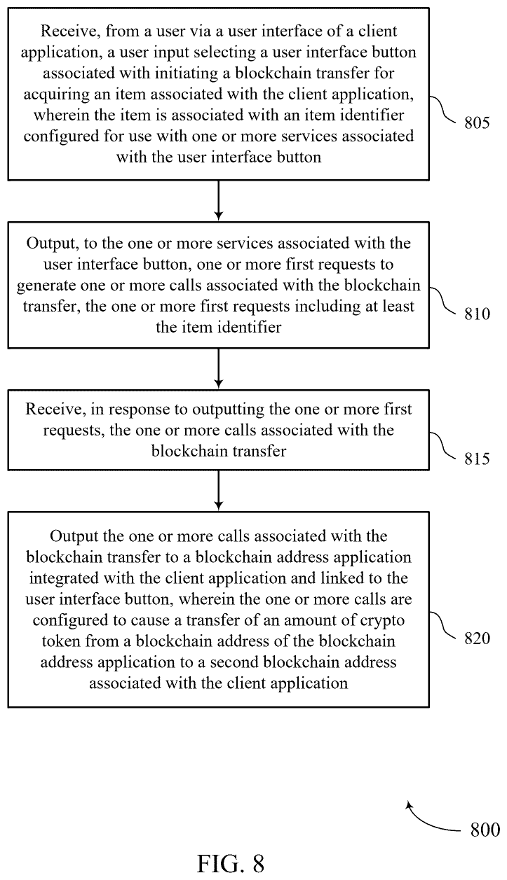

FIG. 8 shows a flowchart illustrating a method 800 that supports initiating blockchain messages based on an integrated user interface button in accordance with aspects of the present disclosure. The operations of the method 800 may be implemented by a user device or its components as described herein. For example, the operations of the method 800 may be performed by a user device as described with reference to FIGS. 1 through 7. In some examples, a user device may execute a set of instructions to control the functional elements of the user device to perform the described functions. Additionally, or alternatively, the user device may perform aspects of the described functions using special-purpose hardware.

At 805, the method may include receiving, from a user via a user interface of a client application, a user input selecting a user interface button associated with initiating a blockchain transfer for acquiring an item associated with the client application, wherein the item is associated with an item identifier configured for use with one or more services associated with the user interface button. The operations of 805 may be performed in accordance with examples as disclosed herein. In some examples, aspects of the operations of 805 may be performed by a button selection component 625 as described with reference to FIG. 6.

At 810, the method may include outputting, to the one or more services associated with the user interface button, one or more first requests to generate one or more calls associated with the blockchain transfer, the one or more first requests including at least the item identifier. The operations of 810 may be performed in accordance with examples as disclosed herein. In some examples, aspects of the operations of 810 may be performed by a call request component 630 as described with reference to FIG. 6.

At 815, the method may include receiving, in response to outputting the one or more first requests, the one or more calls associated with the blockchain transfer. The operations of 815 may be performed in accordance with examples as disclosed herein. In some examples, aspects of the operations of 815 may be performed by a call reception component 635 as described with reference to FIG. 6.

At 820, the method may include outputting the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application. The operations of 820 may be performed in accordance with examples as disclosed herein. In some examples, aspects of the operations of 820 may be performed by a call outputting component 640 as described with reference to FIG. 6.

A method for digital token management by an apparatus is described. The method may include receiving, from a user via a user interface of a client application, a user input selecting a user interface button associated with initiating a blockchain transfer for acquiring an item associated with the client application, wherein the item is associated with an item identifier configured for use with one or more services associated with the user interface button, outputting, to the one or more services associated with the user interface button, one or more first requests to generate one or more calls associated with the blockchain transfer, the one or more first requests including at least the item identifier, receiving, in response to outputting the one or more first requests, the one or more calls associated with the blockchain transfer, and outputting the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application.

An apparatus for digital token management is described. The apparatus may include one or more memories storing processor executable code, and one or more processors coupled with the one or more memories. The one or more processors may individually or collectively be operable to execute the code to cause the apparatus to receive, from a user via a user interface of a client application, a user input selecting a user interface button associated with initiating a blockchain transfer for acquiring an item associated with the client application, wherein the item is associated with an item identifier configured for use with one or more services associated with the user interface button, output, to the one or more services associated with the user interface button, one or more first requests to generate one or more calls associated with the blockchain transfer, the one or more first requests including at least the item identifier, receive, in response to outputting the one or more first requests, the one or more calls associated with the blockchain transfer, and output the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application.

Another apparatus for digital token management is described. The apparatus may include means for receiving, from a user via a user interface of a client application, a user input selecting a user interface button associated with initiating a blockchain transfer for acquiring an item associated with the client application, wherein the item is associated with an item identifier configured for use with one or more services associated with the user interface button, means for outputting, to the one or more services associated with the user interface button, one or more first requests to generate one or more calls associated with the blockchain transfer, the one or more first requests including at least the item identifier, means for receiving, in response to outputting the one or more first requests, the one or more calls associated with the blockchain transfer, and means for outputting the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application.

A non-transitory computer-readable medium storing code for digital token management is described. The code may include instructions executable by one or more processors to receive, from a user via a user interface of a client application, a user input selecting a user interface button associated with initiating a blockchain transfer for acquiring an item associated with the client application, wherein the item is associated with an item identifier configured for use with one or more services associated with the user interface button, output, to the one or more services associated with the user interface button, one or more first requests to generate one or more calls associated with the blockchain transfer, the one or more first requests including at least the item identifier, receive, in response to outputting the one or more first requests, the one or more calls associated with the blockchain transfer, and output the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application.

In some examples of the method, apparatus, and non-transitory computer-readable medium described herein, the blockchain address application comprises a smart address application accessible via a passkey of a user device, the one or more calls comprises an approval message associated with approving the transfer of the crypto token and a transfer message associated with transferring the amount of the crypto token to the second blockchain address, and outputting the one or more calls comprises outputting the approval message and the transfer message in a batched configuration for a single signature procedure, by the smart address application, to cause the transfer of the amount of the crypto token.

In some examples of the method, apparatus, and non-transitory computer-readable medium described herein, outputting the one or more first requests to generate the one or more calls may include operations, features, means, or instructions for outputting the one or more first requests in response to the user interface button being rendered at a user device and prior to receiving the user input.

Some examples of the method, apparatus, and non-transitory computer-readable medium described herein may further include operations, features, means, or instructions for causing display, at the blockchain address application and based at least in part on satisfaction of one or more message criteria, information associated with transferring the amount to obtain the item.

In some examples of the method, apparatus, and non-transitory computer-readable medium described herein, the one or more message criteria comprise the crypto token being a defined crypto token type, the one or more calls being configured to cause the blockchain address application to avoid paying message fees, or both.

In some examples of the method, apparatus, and non-transitory computer-readable medium described herein, the display excludes other blockchain message information associated with the transfer based at least in part on satisfaction of the one or more message criteria.

Some examples of the method, apparatus, and non-transitory computer-readable medium described herein may further include operations, features, means, or instructions for transmitting, to the one or more services, a second request to generate the item identifier for the item and receiving, from the one or more services in response to the second request to generate the item identifier, the item identifier.

In some examples of the method, apparatus, and non-transitory computer-readable medium described herein, outputting the one or more first requests to generate the one or more calls may include operations, features, means, or instructions for transmitting, to a first service associated with the client application, a first request for an identifier for a charge associated with the item identifier and transmitting, to a second service associated with the user interface button, a second request to hydrate the charge associated with the item identifier, wherein the received one or more calls comprise the charge hydrated with transfer information.

In some examples of the method, apparatus, and non-transitory computer-readable medium described herein, outputting the one or more first requests to generate the one or more calls may include operations, features, means, or instructions for outputting, to the one or more services, a request to generate a hydrated charge, wherein the received one or more calls comprise a charge hydrated with transfer information.

Some examples of the method, apparatus, and non-transitory computer-readable medium described herein may further include operations, features, means, or instructions for receiving, from the one or more services in response to outputting the one or more calls, an indication that the transfer of the amount of crypto token may be confirmed on a blockchain network.

A method for digital token management by an apparatus is described. The method may include receiving, from a user via a user interface of a client application, a user input selecting a user interface button associated with initiating a blockchain transfer for acquiring an item associated with the client application, wherein the item is associated with an item identifier configured for use with one or more services associated with the user interface button, output, to the one or more services associating with the user interface button, one or more first requests to generate one or more calls associated with the blockchain transfer, the one or more first requests including at least the item identifier, receiving, in response to outputting the one or more first requests, the one or more calls associated with the blockchain transfer, outputting the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application, and causing display, at the blockchain address application and based at least in part on satisfaction of one or more message criteria, information associated with transferring the amount to obtain the item.

An apparatus for digital token management is described. The apparatus may include one or more memories storing processor executable code, and one or more processors coupled with the one or more memories. The one or more processors may individually or collectively be operable to execute the code to cause the apparatus to receive, from a user via a user interface of a client application, a user input selecting a user interface button associated with initiating a blockchain transfer for acquiring an item associated with the client application, wherein the item is associated with an item identifier configured for use with one or more services associated with the user interface button, output, to the one or more services associated with the user interface button, one or more first requests to generate one or more calls associated with the blockchain transfer, the one or more first requests including at least the item identifier, receive, in response to outputting the one or more first requests, the one or more calls associated with the blockchain transfer, output the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application, and causing display, at the blockchain address application and based at least in part on satisfaction of one or more message criteria, information associated with transferring the amount to obtain the item.

Another apparatus for digital token management is described. The apparatus may include means for receiving, from a user via a user interface of a client application, a user input selecting a user interface button associated with initiating a blockchain transfer for acquiring an item associated with the client application, wherein the item is associated with an item identifier configured for use with one or more services associated with the user interface button, means for output, to the one or more services associating with the user interface button, one or more first requests to generate one or more calls associated with the blockchain transfer, the one or more first requests including at least the item identifier, means for receiving, in response to outputting the one or more first requests, the one or more calls associated with the blockchain transfer, means for outputting the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application, and means for causing display, at the blockchain address application and based at least in part on satisfaction of one or more message criteria, information associated with transferring the amount to obtain the item.

A non-transitory computer-readable medium storing code for digital token management is described. The code may include instructions executable by one or more processors to receive, from a user via a user interface of a client application, a user input selecting a user interface button associated with initiating a blockchain transfer for acquiring an item associated with the client application, wherein the item is associated with an item identifier configured for use with one or more services associated with the user interface button, output, to the one or more services associated with the user interface button, one or more first requests to generate one or more calls associated with the blockchain transfer, the one or more first requests including at least the item identifier, receive, in response to outputting the one or more first requests, the one or more calls associated with the blockchain transfer, output the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application, and causing display, at the blockchain address application and based at least in part on satisfaction of one or more message criteria, information associated with transferring the amount to obtain the item.

Another apparatus for digital token management is described. The apparatus may include one or more memories storing processor-executable code, one or more processors coupled with the one or more memories and individually or collectively operable to execute the code to cause the apparatus to, receive, from a user via a user interface of a client application, a user input selecting a user interface button associated with initiating a blockchain transfer for acquiring an item associated with the client application, wherein the item is associated with an item identifier configured for use with one or more services associated with the user interface button, output, to the one or more services associated with the user interface button, one or more first requests to generate one or more calls associated with the blockchain transfer, the one or more first requests including at least the item identifier, receive, in response to out, the one or more calls associated with the blockchain transfer, and output the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application, wherein the blockchain address application comprises a smart address application accessible via a passkey of a user device.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for digital token management, comprising:
receiving, from a user via a user interface of a client application, a user input selecting a user interface button associated with initiating a blockchain transfer for acquiring an item associated with the client application, wherein the item is associated with an item identifier configured for use with one or more services associated with the user interface button, wherein the user interface button is provided by a software development kit (SDK) integrated with the client application and configured to facilitate communication between the client application and the one or more services associated with the user interface button;
outputting, to the one or more services associated with the user interface button, one or more first requests to generate one or more calls associated with the blockchain transfer, wherein the SDK generates the one or more first requests on behalf of the client application and causes the one or more first requests to include at least the item identifier;
receiving, in response to outputting the one or more first requests, the one or more calls associated with the blockchain transfer via the SDK; and
outputting, via the SDK, the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application.

2. The method of claim 1, wherein:
the blockchain address application comprises a smart address application accessible via a passkey of a user device,
the one or more calls comprises an approval message associated with approving the transfer of the crypto token and a transfer message associated with transferring the amount of the crypto token to the second blockchain address, and
outputting the one or more calls comprises outputting the approval message and the transfer message in a batched configuration for a single signature procedure, by the smart address application, to cause the transfer of the amount of the crypto token.

3. The method of claim 1, wherein outputting the one or more first requests to generate the one or more calls comprises:
outputting the one or more first requests in response to the user interface button being rendered at a user device and prior to receiving the user input.

4. The method of claim 1, further comprising:
causing a display, at the blockchain address application and based at least in part on satisfaction of one or more message criteria, of information associated with transferring the amount to obtain the item.

5. The method of claim 4, wherein the one or more message criteria comprise the crypto token being a defined crypto token type, the one or more calls being configured to cause the blockchain address application to avoid paying message fees, or both.

6. The method of claim 4, wherein the display excludes other blockchain message information associated with the transfer based at least in part on satisfaction of the one or more message criteria.

7. The method of claim 1, further comprising:
transmitting, to the one or more services, a second request to generate the item identifier for the item; and
receiving, from the one or more services in response to the second request to generate the item identifier, the item identifier.

8. The method of claim 1, wherein outputting the one or more first requests to generate the one or more calls comprises:
transmitting, to a first service associated with the client application, a first request for an identifier for a charge associated with the item identifier; and
transmitting, to a second service associated with the user interface button, a second request to hydrate the charge associated with the item identifier, wherein the received one or more calls comprise the charge hydrated with transfer information.

9. The method of claim 1, wherein outputting the one or more first requests to generate the one or more calls comprises:
outputting, to the one or more services, a request to generate a hydrated charge, wherein the received one or more calls comprise a charge hydrated with transfer information.

10. The method of claim 1, further comprising:
receiving, from the one or more services in response to outputting the one or more calls, an indication that the transfer of the amount of crypto token is confirmed on a blockchain network.

11. An apparatus for digital token management, comprising:
one or more memories storing processor-executable code; and
one or more processors coupled with the one or more memories and individually or collectively operable to execute the code to cause the apparatus to:
receive, from a user via a user interface of a client application, a user input selecting a user interface button associated with initiating a blockchain transfer for acquiring an item associated with the client application, wherein the item is associated with an item identifier configured for use with one or more services associated with the user interface button, wherein the user interface button is provided by a software development kit (SDK) integrated with the client application and configured to facilitate communication between the client application and the one or more services associated with the user interface button;
output, to the one or more services associated with the user interface button, one or more first requests to generate one or more calls associated with the blockchain transfer, wherein the SDK generates the one or more first requests on behalf of the client application and causes the one or more first requests to include at least the item identifier;
receive, in response to outputting the one or more first requests, the one or more calls associated with the blockchain transfer via the SDK; and
output, via the SDK, the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application.

12. The apparatus of claim 11, wherein:
the blockchain address application comprises a smart address application accessible via a passkey of a user device,
the one or more calls comprises an approval message associated with approving the transfer of the crypto token and a transfer message associated with transferring the amount of the crypto token to the second blockchain address, and
to output the one or more calls, the one or more processors are individually or collectively further operable to output the approval message and the transfer message in a batched configuration for a single signature procedure, by the smart address application, to cause the transfer of the amount of the crypto token.

13. The apparatus of claim 11, wherein, to output the one or more first requests to generate the one or more calls, the one or more processors are individually or collectively further operable to:
output the one or more first requests in response to the user interface button being rendered at a user device and prior to receiving the user input.

14. The apparatus of claim 11, wherein the one or more processors are individually or collectively further operable to:
cause a display, at the blockchain address application and based at least in part on satisfaction of one or more message criteria, of information associated with transferring the amount to obtain the item.

15. The apparatus of claim 14, wherein the one or more message criteria comprise the crypto token being a defined crypto token type, the one or more calls being configured to cause the blockchain address application to avoid paying message fees, or both.

16. The apparatus of claim 14, wherein the display excludes other blockchain message information associated with the transfer based at least in part on satisfaction of the one or more message criteria.

17. The apparatus of claim 11, wherein the one or more processors are individually or collectively further operable to:
transmit, to the one or more services, a second request to generate the item identifier for the item; and
receive, from the one or more services in response to the second request to generate the item identifier, the item identifier.

18. The apparatus of claim 11, wherein, to output the one or more first requests to generate the one or more calls, the one or more processors are individually or collectively further operable to:
transmit, to a first service associated with the client application, a first request for an identifier for a charge associated with the item identifier; and
transmit, to a second service associated with the user interface button, a second request to hydrate the charge associated with the item identifier, wherein the received one or more calls comprise the charge hydrated with transfer information.

19. The apparatus of claim 11, wherein, to output the one or more first requests to generate the one or more calls, the one or more processors are individually or collectively further operable to:
output, to the one or more services, a request to generate a hydrated charge, wherein the received one or more calls comprise a charge hydrated with transfer information.

20. A non-transitory computer-readable medium storing code for digital token management, the code comprising instructions executable by one or more processors to:
receive, from a user via a user interface of a client application, a user input selecting a user interface button associated with initiating a blockchain transfer for acquiring an item associated with the client application, wherein the item is associated with an item identifier configured for use with one or more services associated with the user interface button, wherein the user interface button is provided by a software development kit (SDK) integrated with the client application and configured to facilitate communication between the client application and the one or more services associated with the user interface button;
output, to the one or more services associated with the user interface button, one or more first requests to generate one or more calls associated with the blockchain transfer, wherein the SDK generates the one or more first requests on behalf of the client application and causes the one or more first requests to include at least the item identifier;
receive, in response to outputting the one or more first requests, the one or more calls associated with the blockchain transfer via the SDK;
output, via the SDK, the one or more calls associated with the blockchain transfer to a blockchain address application integrated with the client application and linked to the user interface button, wherein the one or more calls are configured to cause a transfer of an amount of crypto token from a blockchain address of the blockchain address application to a second blockchain address associated with the client application; and
cause display, at the blockchain address application and based at least in part on satisfaction of one or more message criteria, information associated with transferring the amount to obtain the item.
